(19) United States
(12) Patent Application Publication
(10) Pub. No.: US 2010/0299150 A1
(43) Pub. Date: Nov. 25, 2010

(54) Language Translation System

(76) Inventors: Gene S. Fein, Malibu, CA (US); Edward A. Merritt, Lenox, MA (US)

Correspondence Address: Whitaker Law Group, 1218 Third Avenue, Suite 1809, Seattle, WA, 98101, US

(21) Appl. No.: 12/470,731

(22) Filed: May 22, 2009

(51) Int. Cl. G10L 21/00

(52) U.S. Cl. 704/277

(57) ABSTRACT

A language translation system is generally described that facilitates parties who speak different languages to communicate with one another as though each were speaking the same language on their respective communication devices. Example language translation systems include language translation components for translating from one language to another language.

### BACKGROUND

Voice communication over cellular phones, internet phones, and other communication devices have allowed individuals from different countries the ability to talk with each other quite easily. However, communicating over these devices is difficult if the individuals do not speak the same language and cannot understand each other.

### BRIEF DESCRIPTION OF THE DRAWINGS

The features of the present disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings, in which:

FIG. 1 is a functional block diagram generally illustrating a language translation system;

FIG. 2 is a block diagram of illustrative language translation components that implement functionality that provides communication between, and/or among, individuals communicating using different language styles and/or different languages;

FIG. 3 is a diagram that illustrates one example interaction of communication devices used by individuals speaking different languages;

FIG. 4 is a diagram that illustrates another example interaction of communication devices used by individuals speaking different languages;

FIG. 5 is a diagram that illustrates still another example interaction of communication devices used by individuals speaking different languages;

FIG. 6 is a diagram generally illustrating a computer product configured to provide language translation; and

FIG. 7 is functional block diagram of an example computing device that may be configured for implementing a portion of the language translation components for the language translation system shown in FIG. 1; all arranged in accordance with at least some embodiments of the present disclosure.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the Figures, can be arranged, substituted, combined, and designed in a wide variety of different configurations, all of which are explicitly contemplated and made part of this disclosure.

This disclosure is generally drawn, inter alia, to methods, apparatus, computer programs and systems related to a language translation system. In overview, the language translation system may be configured so that an individual speaking one language using a communication device may be able to understand and communicate with another individual speaking another language using another communication device. The communication devices used by the individuals may be similar or may be different. In addition, one or both of the communication devices may specify a source language and/or a target language. The language translation system may be configured to perform the specified language translation in a manner such that both individuals, speaking different languages, may understand each other as if they were both communicating using the same language. The language translation system may provide an infrastructure in which conversations may be translated live and in near real-time in accordance with at least some embodiments of the present disclosure. The communication may occur using a mobile device, a non-mobile device, such as computers using VOIP (voice over internet protocol), conventional landline phones, and any other type of communication device.

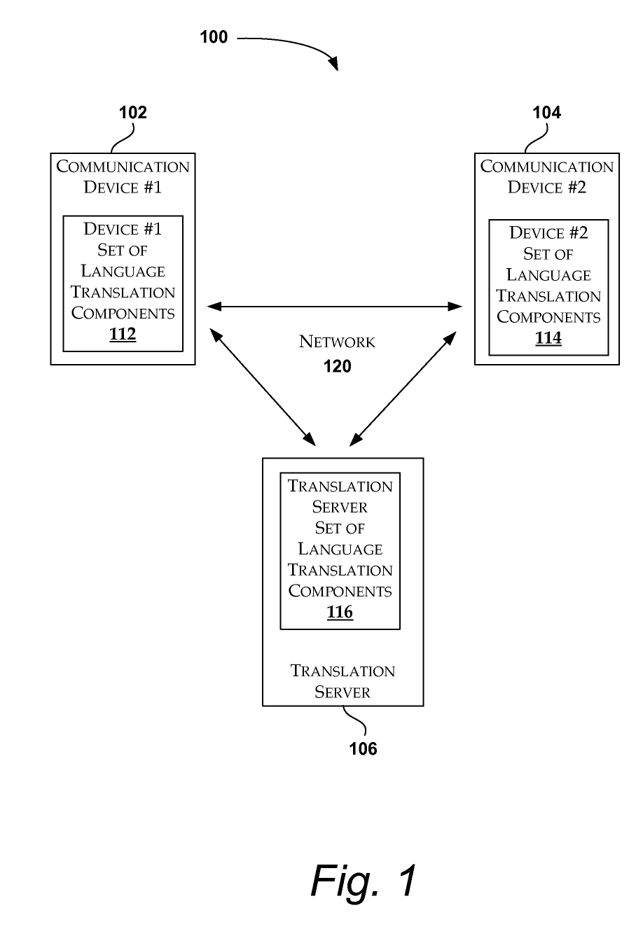

FIG. 1 is a functional block diagram generally illustrating a language translation system 100, in accordance with at least some embodiments of the present disclosure. The language translation system 100 includes a communication device 102 (e.g., Communication Device #1) and another communication device 104 (e.g., Communication Device #2). The language translation system 100 may also include a translation server 106.

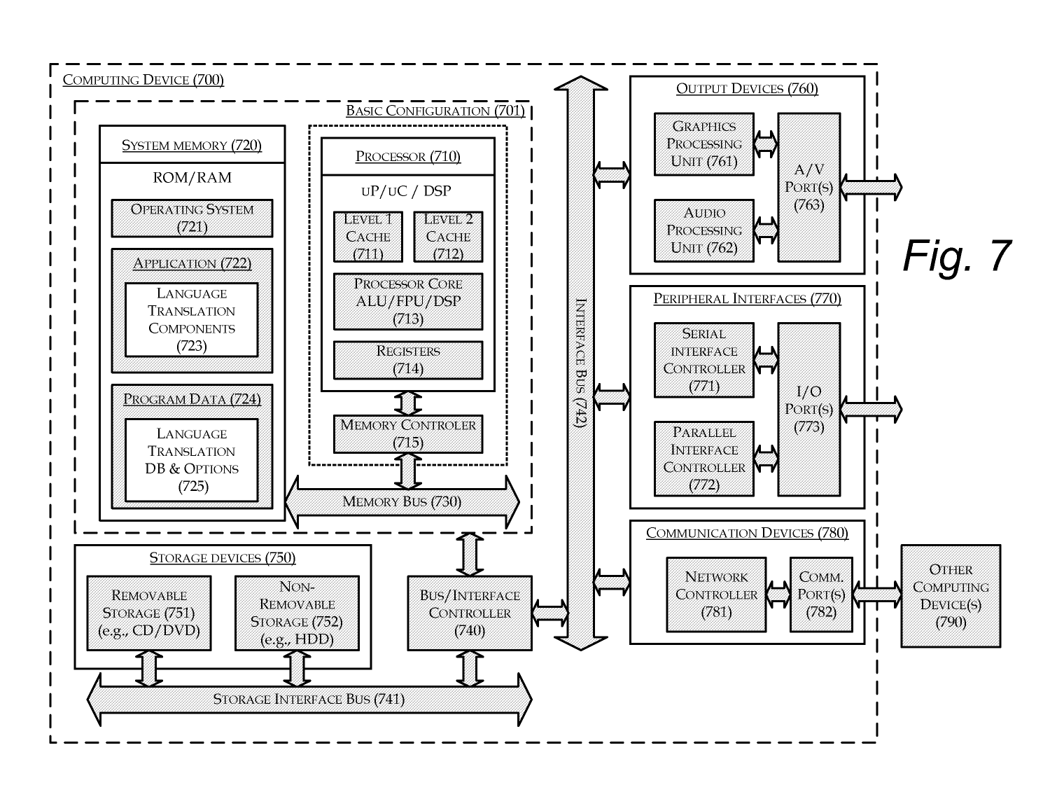

Communication device 102 may be of any type of communication device including, but not limited to, a cellular phone, a computer using VOIP (Voice Over Internet Protocol), a POTS (Plain Old Telephone Service) phone, a personal digital assistant, or a smart phone. Communication device 104 may also be any type of communication device and may be a different type than communication device 102. For example, one communication device may be VOIP on a computer and the other communication device may be a cellular phone. These and other types of communication devices are envisioned to use the language translation system of the present disclosure. An example computing device, illustrated in FIG. 7 and described below, may be configured as a communication device as shown in FIG. 1.

Communication device 102 and 104 may be arranged to establish a call over communication network 120 for a conversation. Communication network 120 may be one of any type including but not limited to a wireless network, a cellular network, a POTS (plain old telephone service) network, a wired network, or any combination thereof. These communication networks are well known to those skilled in the art and need not be further described. The communication network 120 may allow individuals using communication device 102 and 104 the ability to establish a call (i.e., a communication session), where a conversation may follow. The individuals may be located in different areas of a country, in different countries, or may be neighbors. In order to realize the benefits of the present language translation system, individuals using communication devices 102 and 104 may communicate using different languages and/or a different communication styles. Communication style refers to a communication technique such as using a spoken language, using a non-verbal language, such as sign language or Braille, and the like. As will be explained below, even though the individuals may be communicating using different communication styles and/or languages, each individual may perceive the conversation as if the other individual is communicating using the same style and/or same language.

In at least some embodiments, communication device 102 may be arranged to communicate with the other communication device 104 via network 120 without using transaction server 106 as an intermediary (e.g., a peer-to-peer based network topology). For these embodiments, the network 120 may not necessarily implement any additional functionality to support the language translation system of the present disclosure. In other embodiments, communication device 102 may communicate with the other communication device 104 via an intermediary, such as translation server 106, over network 120 (e.g., a server based network topology). For these embodiments, the translation server 106 may provide additional functionality that may support language translation in accordance with at least some embodiments of the present disclosure.

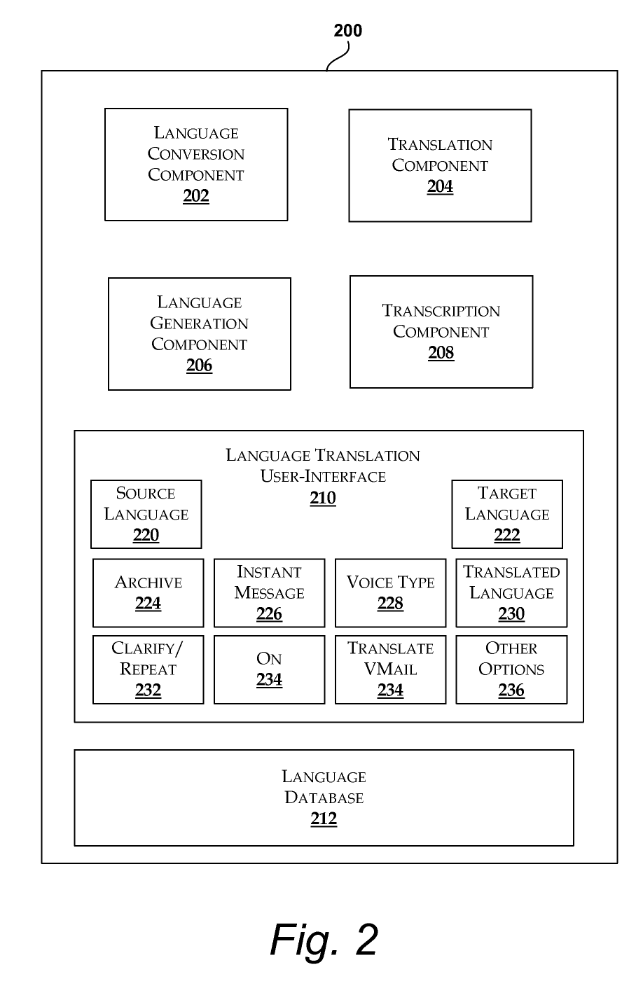

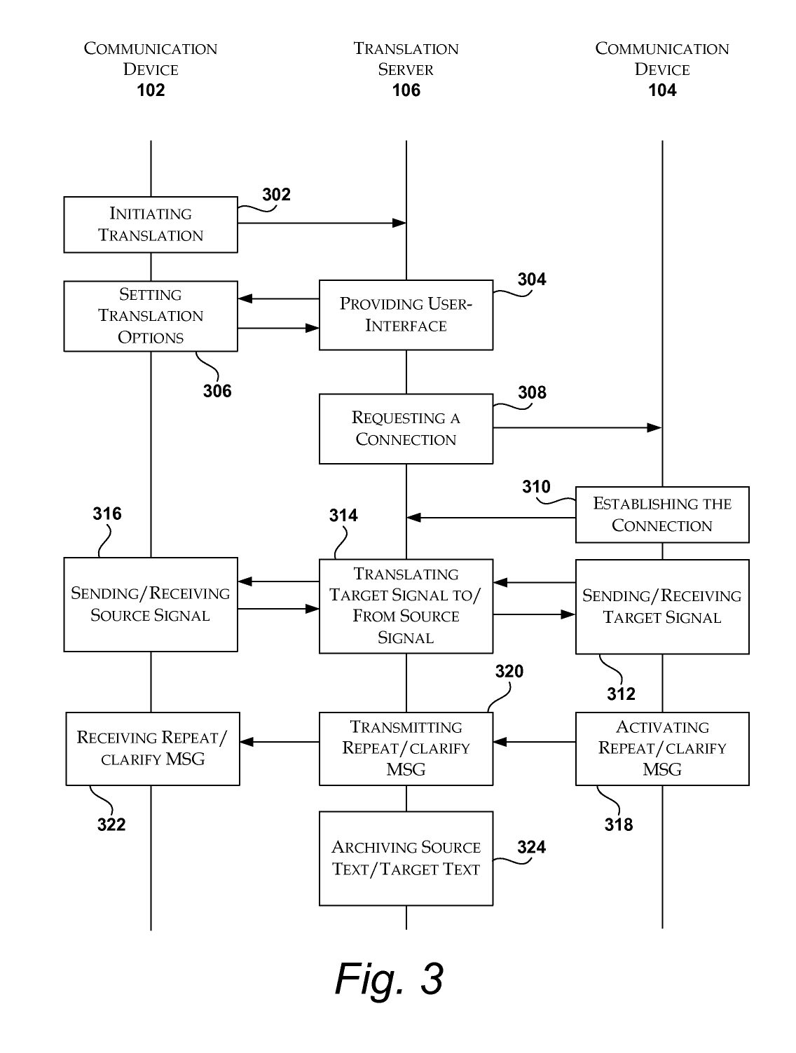

The language translation system may also include one or more language translation components that may provide functionality for the language translation system in accordance with at least some embodiments of the present disclosure. The language translation components will be described later in more detail in conjunction with FIG. 2. Briefly, language translation components may allow a user of communication device 102 speaking one language to communicate with another user on communication device 104 speaking a different language. Each device may use the same or use a different set of language translation components in order to achieve the near real-time language translation in accordance with at least some embodiments of the present disclosure. FIGS. 3-5 illustrate some example configurations and arrangements of the language translation components for supporting various types of communication scenarios. FIG. 1 illustrates communication device 102 with set 112 of translation components, communication device 104 with set 114 of language translation components, and translation server 106 with set 116 of language translation components. Sets 114 and 116 may share some or all of the language translation components and/or may have unique sets of the language translation components. In addition, in at least some embodiments, a communication device may not have any of the language translation components residing on the communication device itself, but may access the functionality provided by the language translation components via language translation server 106.

While FIG. 1 illustrates two communication devices (e.g., communication device 102 and communication device 104), one will appreciate after reading the present disclosure that multiple communication devices may be included in the language translation system. For example, the multiple communication devices may be engaged in a conference call, where each communication device may establish a desired source language. The language translation components may then translate the dialog of the conference call for each individual communication device using the desired source language associated with the respective communication device in accordance with the present disclosure.

FIG. 2 is a block diagram of illustrative language translation components that implement functionality that provides communication between, and/or among, individuals communicating using different language styles and/or different languages, in accordance with at least some embodiments of the present disclosure. As illustrated, the language translation components 200 may include one or more of a language conversion component 202, a translation component 204, a language generation component 206, a transcription component 208, a language translation user-interface 210, and/or a language database 212.

As will be recognized in light of the present disclosure, one or more of the other components may provide the functionality provided by one component without departing from the scope of the present disclosure. The break up of the functionality into components is merely to aid in the description of the present disclosure, and not intended to limit implementations to the functional partitions described herein. The functionality provided by each illustrated functional component is described below.

The language conversion component 202 may be arranged to convert a source signal into text. The source signal may be a spoken audio signal, a recorded audio signal, an electronic file (such as for Braille), a data packet encapsulating the voice signal and the like. The source signal may be associated with a source language, meaning that the audio and/or electronic content of the source signal may use the dialect of the source language (e.g., French, English, Spanish, etc.). The source language may be a spoken language or a non-spoken language, for example a sign language or Braille. In embodiments in which the source language may be a sign language, the language conversion component 202 may include a conventional software application that converts sign language to text. In embodiments in which the source language may be Braille, the language conversion component 202 may include a conventional Braille reader that converts Braille to text. In embodiments in which the source language may be a spoken language, the language conversion component may include a voice recognition module that is arranged to convert one of the many languages spoken around the world into text of the respective language.

The translation component 204 may be arranged to translate text (hereinafter referred to as source text) from one language (i.e., source language) into text (hereinafter referred to as target text) of another language (i.e., target language). The translation component 204 may be adapted to receive information about the source language and the target language from the language translation user-interface 210. The translation component 204 may be arranged to use any conventional translation software for translating the source text to the target text. In at least some embodiments, translation component 204 may be arranged to use language database 212, described in more detail below, for the translation.

The language generation component 206 may be arranged to convert the target text into a target signal. The target signal may be a spoken audio signal, a recorded audio signal, an electronic file (such as for Braille), and the like. The target signal may be associated with a target language, meaning that the audio and/or electronic content of the target signal may use the dialect of the target language (e.g., French, English, Spanish, etc.). For example, the target language may be one of several spoken languages and/or may be based a non-spoken language, such as a sign language, Braille, or the like. In embodiments in which the target language may be one of several spoken languages, the language generation component may include a voice generator that generates the spoken language in one or more various voices, such as a synthetic voice, a user simulated voice, or the like. The language generation component 206 may be adapted to receive settings regarding the target language from the language translation user-interface 210.

The transcription component 208 may be arranged to archive a transcript in each of the target languages associated with respective communication devices. The archived transcript may then be retrieved later in response to a pass code entered into the user interface 210 by a user. The transcription component 208 may also make the archived transcript available to users by transmitting the archived transcript via email to different users, by providing a downloadable version of the archived transcript from an internet address, or the like. The transcription component 204 may also be configured to send a transcript to one or more communication devices as the dialog occurs, such as sending instant messages of the dialog to the participants and/or other designated individuals. By providing an instant message with the transcript of the conversation, the participants may be enabled to understand the conversation better and/or may review previous points that have been discussed.

The language translation user-interface 210 may be arranged to provide an interface for a user of a communication device to enter translation options. Translation options may include, but are not limited to, one or more of a source language 220, a target language 222, an archive 224 option, an instant message 226 option, a voice type 228, a translated language 230, a clarify/repeat 232 option, an ON 234 option, a translate voice mail 234 option, and/or other options 236. For example, a user may specify via the language translation user-interface 210 whether the source language 220 and/or the target language 222 may be a spoken language and or a non-spoken language. A variety of spoken languages, such as English, Spanish, French, may be available via a pull-down menu in the language translation user-interface 210. In addition, non-spoken languages may be available via a pull-down menu in the language translation user-interface 210. The language translation user-interface 210 may also be adapted to allow a user to specify an archive option 224 for archiving of the dialog or may be adapted to allow a user to specify an instant message option 226 for sending instant messages of the dialog during the conversation.

The language translation user-interface 210 may also be adapted to allow a user to specify a voice type 228, such as a synthetic voice, a user simulated voice, or the like for a translated language, where the translated language 230 may refer to the language that will be converted from another party. In some implementations, the user may desire to speak and hear in the same language. In other words, the selected translated language and the selected source language may be the same language for one communication device, and the selected translated language and the selected target language may be the same language for the other communication device. However, there may be situations in which a user may want to speak one language (the source language) and hear responses in another language (translated language). In this case, the selected translated language and the selected source language may be different languages from one another. Portions of the language translation user-interface 210 may reside on the language translation server and/or one or more of the communication devices. In some examples, the portions residing on the language translation server may be distributed to multiple computing devices functioning collectively as the language translation server. In at least some embodiments, the language translation server may be configured to provide a browser like interface for the communication devices to access and set the options. In at least some other embodiments, the language translation server may be arranged to provide a voice menu whereby callers may select the translation options using keys on a keypad, by voice commands, and/or by a touchpad.

The language translation user-interface 210 may also provide a clarify/repeat option 232. The clarify/repeat option 232 may be activated by one party and arranged to request that the other party restate a portion of the dialogue that did not make sense to them. The other party may then re-state a portion of the dialogue and/or provide additional information to aid the party in understanding.

The language translation user-interface 210 may also include a translation “ON” 234 option, which may be arranged to initiate the language translation services in accordance with the present disclosure. For example, if a caller calls a phone number expecting to connect with a person who speaks the same language, but actually connects with a person who speaks a different language, the caller may activate the translation “ON” option of the language translation user interface 210 to initiate the translation service. The caller may then begin to receive the dialogue from the callee in the caller's language. In at least some embodiment, the callee may also then automatically begin receiving the caller's dialogue in the callee's language. The language translation user interface 210 may be adapted to activate the translation “ON” 234 option by a button on the communication device (e.g., hardkey and/or softkey), by a voice command, by a call, or the like.

The language translation user-interface 210 may also be arranged to provide a translate voice mail 234 option that may allow a user to send a translated message in accordance with the present disclosure. The translated message may be sent as a voice mail message, as an attachment to an email message, to an Internet address for later retrieval, and the like.

The language database 212 may be adapted for use in conjunction with one or more of the other components, such as the language conversion component 202, the translation component 204, and/or the language generation component 206. Portions of the language database 212 may reside on the language translation server and/or one or more of the communication devices. In addition, the portions residing on the language translation server may be distributed to multiple computing devices. The language database 212 may use any conventional technique for coordinating one language to another language.

FIGS. 3-5 illustrate different implementations of the language translation system in accordance with the present disclosure. The different implementations have different configurations of the language translation components for the communication devices and the language translation server. While FIGS. 3-5 illustrate three different implementations, one will appreciate that other implementations may be implemented in accordance with the present disclosure and that FIGS. 3-5 provide non-exhaustive examples of suitable implementations. In addition, FIGS. 3-5 illustrate interactions between two communication device, but one will appreciate that one or multiple communication devices may be configured in accordance with the at least some embodiments of the present disclosure.

FIG. 3 is a diagram that illustrates one example interaction of communication devices used by individuals speaking different languages in accordance with at least some embodiments of the present disclosure. In the embodiments illustrated in FIG. 3, the communication devices (e.g., communication device 102 and communication device 104) may not be configured with any of the language translation components. For example, the communication devices may be conventional landline phones, mobile phones, computers using VOIP, or the like. Transaction server 106 may be configured with one or more of the language translation components and may act as an intermediary between the two communication devices 102 and 104. An example interaction between communication devices 102 and 104 is now described with reference to FIG. 3.

At block 302, initiating translation may be performed. For example, communication device 102 may be arranged to initiate translation with communication device 104 via transaction server 106. While in general, initiating translation may be performed via an action on communication device 102, such as hitting a button, speaking a command, or the like, the communication device 102 may also initiate translation by calling into a certain number to access the language translation system via the transaction server 106, in accordance with the present disclosure. Processing may proceed from block 302 to block 304.

At block 304, providing a user-interface may be performed. For example, translation server 106 may be arranged to provide a user-interface that allows the communication device to enter (or perhaps retrieve) translation options. In at least some embodiments, the user-interface may be a series of menus that the user of communication device 102 may select using keys on the communication device 102 and/or may select by speaking in response to voice prompts. Processing may proceed from block 304 to block 306.

At block 306, setting translation options may be performed. For example, communication device 102 may be arranged to use the user-interface to set translation options, such as a source language indicating the language that the user will be speaking and a target language indicating the language that the user of the other communication device (e.g., communication device 104) will be using. In addition, communication device 102 may be arranged to set other translation options, such as transcription services (e.g., archiving, instant messages). Processing may proceed from block 306 to block 308.

At block 308, requesting a connection between two or more communication devices may be performed. For example, translation server 106 may be arranged to dial a number associated with communication device 104 based on information that may be provided by communication device 102. Processing may proceed from block 308 to block 310.

At block 310, establishing the connection between two or more communication devices may be performed. For example, communication device 104 may be arranged to answer the call using conventional techniques and begin speaking. Processing may proceed from block 310 to block 312.

At block 312, sending/receiving a target signal may be performed. Because the user of communication device 102 may have already entered the target language for communication device 104, the target signal transmitted to transaction server 106 may likely be based on the target language. However, when the callee begins talking in a language other than the target language, setting translation options in block 306 may be modified by communication device 102 to accommodate the change. Processing may proceed from block 312 to block 314.

At block 314, translating between the target signal and the source signal may be performed by the translation server 106. Depending on the direction of the dialog, the translation may include converting the target signal to target text, converting target text to source text, and generating source signal from the source text, where the source signal may be generated in the dialect of the source language and may be a synthetic voice, a user simulated voice, or other type. When the direction of the dialog is reversed, the translation may include converting the source signal to source text, converting source text to target text, and generating a target signal from the target text, where the target signal may be in the dialect of the target language and may be a synthetic voice, a user simulated voice, or other type. Processing may proceed from block 314 to block 316.

At block 316, sending/receiving the source signal may be performed. For example, transaction server 106 may be arranged to transmit the voice signal to communication device 102. Thus, the user of communication device 102 may hear the spoken words from the user of communication device 104 in the same language that the user of communication device 102 speaks. The processing illustrated in blocks 312 and 316 may be repeated and may be reversed such that the user of communication device 102 may speak the source language, the translation server may translate the source language into a target signal, and may transmit the target signal to the user of communication device 104 so that the user of communication device 104 may hear the reply from the user of communication device 102 in the same language that the user of communication device 104 speak. Other processing may also occur, such as at one or more of block 318, block 320, and/or block 322.

At block 318, activating a repeat/clarify function may be performed. For example, communication device 104 may be arranged to activate a repeat/clarify function via the translation server, such as in response to depressing one or more keys on the communication device. The translation server may be arranged to transmit (block 320 transmitting repeat/clarify message) the request to communication device 102 in a manner such that the user of communication device 102 may be informed to repeat the phrase or to re-state the phrase in another way in order to help the other user understand what is being said when communication device 102 receives (block 322 receiving repeat/clarify message) the message. Activating the repeat/clarify function may also originate with communication device 102 so that the user of communication device 104 may repeat and/or re-state a portion of the dialog in another way to aid understanding.

At block 324, archiving source text and/or target text may be performed. For example, the translation server 106 may be arranged to archive the source text and/or target text based on the translation options that may have been entered. The archive option may also be set as a default. The translation server 106 may be arranged to associate a pass code for the archived text that may need to be entered in order to facilitate access the archived text at a later time.

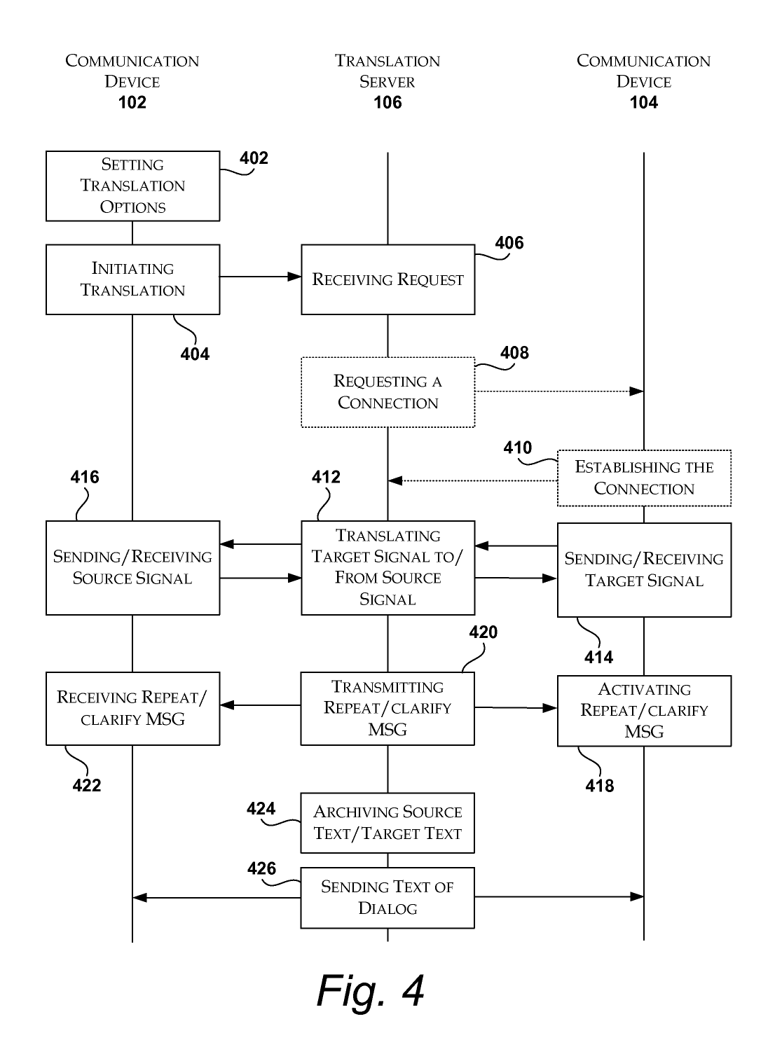

FIG. 4 is a diagram that illustrates another example interaction of communication devices used by individuals speaking different languages in accordance with at least some embodiments of the present disclosure. In the embodiment illustrated in FIG. 4, the communication devices (e.g., communication device 102 and communication device 104) may be configured with one or more of the described language translation components, such as the language translation user-interface. For example, the communication devices 102 and 104 may be mobile phones, computers using VOIP, or the like. Transaction server 106 may be configured with one or more of the language translation components and may act as an intermediary between two or more communication devices (such as communication devices 102 and 104). An example interaction between communication devices 102 and 104 is now described with reference to FIG. 4.

At block 402, setting the translation options may be performed. For example, communication device 102 may be arranged to set the translation options via the user-interface on communication device 102. The user-interface may be a series of pull-down menus which the user of communication device 102 may select by using one or more keys on the communication device, by speaking a command, by tapping a touch screen, or the like.

Using the user-interface, communication device 102 may be arranged to set the translation options, such as a source language indicating the language that the user will be speaking and a target language indicating the language that the user of another communication device (e.g., communication device 104) may be using. In addition, communication device 102 may be arranged to set other translation options, such as transcription services (e.g., archiving, instant messaging). Processing may proceed from block 402 to block 404.

At block 404, initiating translation may occur. For example, communication device 102 may be arranged to initiate translation with communication device 104. Initiating translation may occur after communication device 102 and 104 have already established a communication connection and one of the users recognizes that a translation may be needed. Initiating translation may also occur before communication device 102 and 104 have established a communication connection. Initiating translation may be performed in response to an action on communication device 102, such as hitting a button, speaking a command, or the like in accordance with the present disclosure. Processing may proceed from block 404 to block 406.

At block 406, receiving a request to begin translation, along with the translation options, may be performed. For example, translation server 106 may be arranged to receive the request to begin translation and may receive the translation options from communication device 102. Processing may proceed from block 406 to block 408.

At block 408, requesting a connection between two or more communication devices may be performed. For example, translation server 106 may be arranged to dial a number associated with communication device 104 based on information provided by communication device 102. However, the connection may have been previously connected before initiating translation at block 404 occurred. Processing may proceed from block 408 to block 310.

At block 410, establishing the connection between two or more communication devices may be performed. For example, communication device 104 may be arranged to answer the call using conventional techniques and begin speaking. Processing may proceed from block 410 to blocks 412 and 416.

At block 412, translating between the target signal and source signal may be performed. For example, transaction server 106 may be arranged to translate target signal to source signal and/or source signal to target signal depending on the direction of dialogue between communication devices 102 and 104. In some instances, translation server may be configured to perform both translations at the same time when the dialogs of the individuals overlap. Depending on the direction of the dialog, the translation process may include one or more of converting the target signal to target text, converting target text to source text, and/or generating source signal from the source text, where the source signal may be in the dialect of the source language and may be a synthetic voice, a user simulated voice, or other type. When the direction of the dialog may be reversed, the translation process may include one or more of converting the source signal to source text, converting source text to target text, and/or generating a target signal from the target text, where the target signal may be in the dialect of the target language and may be a synthetic voice, a user simulated voice, or other type. Processing may proceed from block 412 to block 414 and/or block 416.

At block 414, sending/receiving a target signal may be performed. For example, communication device 104 may be adapted to send a target signal to transaction server 106 and/or receive a target signal from transaction server 106.

At block 416, sending/receiving the source signal may be performed. For example, transaction server 106 may be adapted to transmit the voice signal to communication device 102. Thus, the user of communication device 102 may be able to hear the spoken words from the user of communication device 104 in the same language that the user of communication device 102 speaks. The processing illustrated in blocks 412, 414 and 416 may be repeated through out the communication. Other processing may also occur, such as one or more of block 418, block 420, 422, and/or block 424.

At block 418, activating a repeat/clarify function may be performed. For example, communication device 104 may be arranged to activate a repeat/clarify function via the translation server, such as in response to depressing one or more keys on the communication device 104. The translation server may be adapted to transmit (block 420 transmitting repeat/clarify message) the request to communication device 102 in a manner such that the user of communication device 102 is informed to repeat the phrase or to re-state the phrase in another way in order to help the other user understand what is being said when communication device 102 receives (block 422 receiving repeat/clarify message) the message. Activating the repeat/clarify function may also originate with communication device 102 so that the user of communication device 104 may be informed to repeat and/or re-state a portion of the dialog in another way to aid understanding.

At block 424, archiving source text and/or target text may be performed. For example, the translation server 106 may be arranged to archive the source text and/or target text based on the translation options that may have been entered. The archive option may also be set as a default. The translation server 106 may be arranged to associate a pass code for the archived text that may need to be entered in order to access the archived text at a later time.

At block 426, sending text of the dialog may be performed. For example, transaction server 106 may be adapted to send text of the communication to one or both of the communication devices, such as an instant message. The setting for the translation options specified in block 402 may be used to determine whether transcription services are requested or not. The translation options may be modified during a live conversation by accessing the language translation user-interface and changing the desired translation options.

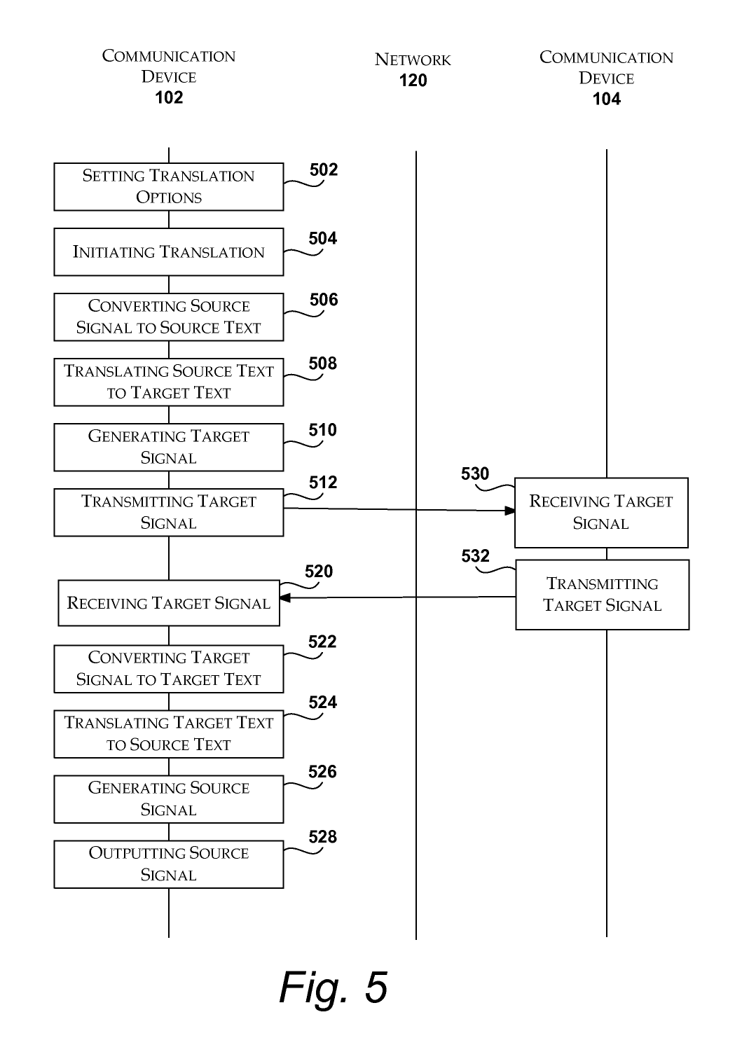

FIG. 5 is a diagram that illustrates still another example interaction of communication devices used by individuals speaking different languages in accordance with at least some embodiments of the present disclosure. In the embodiments illustrated in FIG. 5, one of the communication devices (e.g., communication device 102) may be configured with one or more of the language translation components. In the embodiments illustrated in FIG. 5, transaction server may not be used. Instead, communication device 102 may be configured to perform the language translations. For example, communication device 102 may be a computer using VOIP and communication device 102 may be a POTS telephone. An example interaction between communication devices 102 and 104 is now described with reference to FIG. 5.

At block 502, setting the translation options may be performed. For example, communication device 102 may be arranged to set the translation options via the user-interface on the communication device 102. In some embodiments, the user-interface may be implemented as a series of pull-down menus which the user of communication device 102 may select by using one or more keys on the communication device, by speaking a command, by tapping a touch screen, or the like. Communication device 102 may be arranged to set the translation options, such as a source language indicating the language that the user will be speaking and a target language indicating the language that the user of communication device 104 will be using. In addition, communication device 102 may be arranged to set other translation options, such as transcription services (e.g., archiving, instant message). Processing may proceed from block 502 to block 504.

At block 504, initiating translation may be performed. Initiating translation may occur after communication device 102 and 104 have already established a communication connection and one of the users recognizes that a translation may be needed. Initiating translation may also occur before communication device 102 and 104 have established a communication connection. Initiating translation may be performed in response to an action on communication device 102, such as a user hitting a button, speaking a command, or the like in accordance with the present disclosure. FIG. 5, illustrates communication device 102 activating translation for both devices. Processing may proceed from block 504 to block 506.

At block 506, converting a source signal, such as a voice signal, to text may be performed. For example, communication device 102 may be arranged to convert a voice signal spoken by a user of communication device 102 to source text using the source language. Processing may proceed from block 506 to block 508.

At block 508, translating the source text to target text may be performed. In the embodiments shown in FIG. 5, translating the source text to target text may be performed by communication device 102. The target text may be in the dialect of the user of communication device 104. Processing may proceed from block 508 to block 510.

At block 510, generating a target signal from the target text may be performed. In the embodiments shown in FIG. 5, translating the target text to a target signal may be performed by communication device 102. The target signal may be based on a target language, where the target language may be a spoken language or a non-verbal language, such as sign language or Braille. If the target language is a spoken language, the communication device 104 may use voice generation software to create a voice signal as the target signal. The voice signal may use a synthesized voice, a user simulated voice, or other variations of voice types. Processing may proceed from block 510 to block 512.

At block 512, transmitting the target signal may be performed. For example, communication device 102 may be arranged to transmit the target signal to communication device 104 via a network communication over network 120. Processing may proceed from block 512 to block 530.

At block 530, receiving the target signal may be performed. Because the target signal has already been translated into the language spoken by the user of communication device 104, the user may understand the dialog from the user of communication 102 upon receipt. In the embodiments illustrated in FIG. 5, communication device 104 may not need to perform any translation. One or more of blocks 506, 508, 510 and/or 512 may be repeated each tine new dialog occurs originating from communication device 102. Processing may proceed from block 530 to block 532.

At block 532, transmitting target signal may be performed. For example, communication device 104 may be arranged to transmit the target signal to communication device 102 via a network communication over network 120. The target signal may be a voice signal spoken by the user of communication device 104. The user of communication device 104 may be unaware that translations have occurred. Processing may proceed from block 532 to block 520.

At block 520, receiving target signal may be performed. Communication device 102 may be arranged to receive the target signal from communication device 104 via a network communication over network 120 and begin translating the target signal. Processing may proceed from block 520 to block 522.

At block 522, converting a target signal may be performed. For example, communication device 102 may be arranged to convert a target signal, such as a voice signal, to target text. Processing may proceed from block 522 to block 524.

At block 524, translating the target text into source text may be performed. For example, communication device 102 may be arranged to translate the target text into source text, where the source text may be in the dialect of the user of communication device 102. Processing may proceed from block 524 to block 526.

At block 526, generating source signal from the source text may be performed, such as by communication device 102. The source signal may be based on a source language that may be a spoken language or a non-verbal language, such as sign language or Braille. If the source language is a spoken language, the communication device 102 may be arranged to use voice generation software to create a voice signal as the source signal. The voice signal may use a synthesized voice, a user simulated voice, or other variations of voice types. Processing may proceed from block 526 to block 528.

At block 528, outputting the source signal may be performed, such as by communication device 102. The output may be a Braille manuscript, a visual showing signing, an audio signal, or others depending on the target language type. Processing in one or more of blocks 520, 522, 524, 526, and/or 528 may repeat each time communication device 104 may transmit a new target signal.

While archiving is not shown in FIG. 5, communication device 102 may be configured to create an archive of the communication as explained in conjunction with FIG. 4. FIGS. 3-5 are diagrams that illustrate example interactions between two communication devices. The figures include various illustrative embodiments of operational flows, discussion and explanation may be provided with respect to apparatus and methods described herein, and/or with respect to other examples and contexts. The operational flows may also be executed in a variety of other contexts and environments, and or in modified versions of those described herein. In addition, although some of the operational flows are presented in sequence, the various operations may be performed in various repetitions, concurrently, and/or in other orders than those that are illustrated. The processes described herein may be implemented using computer-executable instructions in software or firmware, but may also be implemented in other ways, such as with programmable logic, electronic circuitry, or the like. In some alternative embodiments, certain of the operations may even be performed with limited human intervention. Moreover, the process is not to be interpreted as exclusive of other embodiments, but rather is provided as illustrative only.

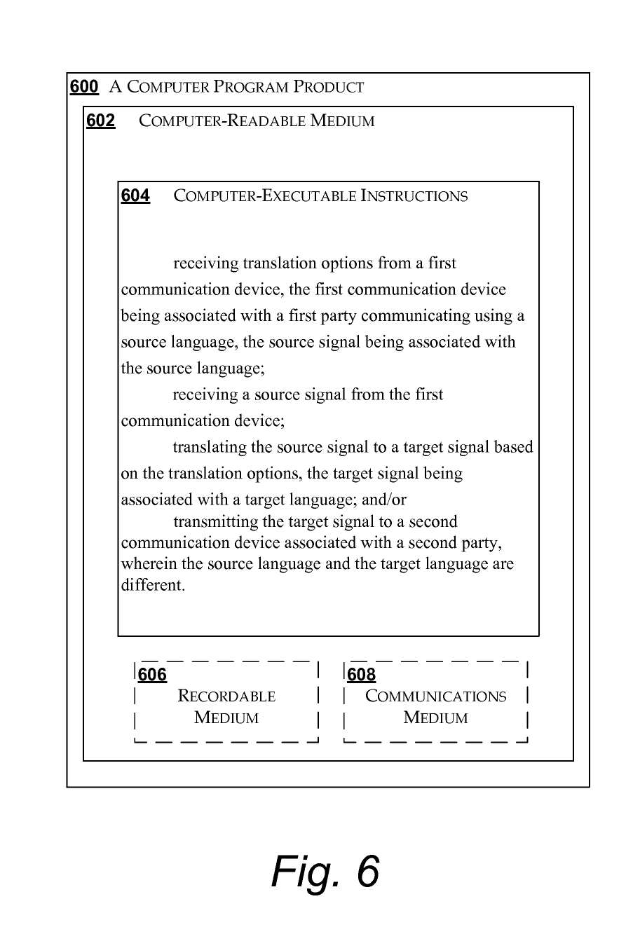

FIG. 6 is a diagram generally illustrating a computer product configured to provide language translation, in accordance with at least some embodiments of the present disclosure. The computer program product 600 may take one of several forms, such as a computer-readable medium 602 having computer-executable instructions 604, a recordable medium 606, a communications medium 608, or the like. When the computer-executable instructions 604 are executed, a method may be performed. The instructions 604 include, among others, one or more of receiving translation options from a first communication device, the first communication device being associated with a first party communicating using a source language, the source signal being associated with the source language; receiving a source signal from the first communication device; translating the source signal to a target signal based on the translation options, the target signal being associated with a target language; and/or transmitting the target signal to a second communication device associated with a second party, wherein the source language and the target language are different.

FIG. 7 is functional block diagram of an example computing device that may be configured for implementing a portion of the language translation components for the language translation system shown in FIG. 1 in accordance with at least some embodiments of the present disclosure. Both communication devices and the language translation server may use the same basic configuration, shown as basic configuration 701 with modifications to the language translation components 723 that are used by the different device. In basic configuration 701, computing device 700 typically includes one or more processors 710 and system memory 720. A memory bus 730 can be used for communicating between the processor 710 and the system memory 720.

Depending on the desired configuration, processor 710 can be of any type including but not limited to a microprocessor (μP), a microcontroller (μC), a digital signal processor (DSP), or any combination thereof. Processor 710 can include one more levels of caching, such as a level one cache 711 and a level two cache 712, a processor core 713, and registers 714. The processor core 713 can include an arithmetic logic unit (ALU), a floating point unit (FPU), a digital signal processing core (DSP Core), or any combination thereof. A memory controller 715 can also be used with the processor 710, or in some implementations the memory controller 715 can be an internal part of the processor 710.

Depending on the desired configuration, the system memory 720 can be of any type including but not limited to volatile memory (such as RAM), non-volatile memory (such as ROM, flash memory, etc.) or any combination thereof. System memory 720 typically includes an operating system 721, one or more applications 722, and program data 724. Application 722 includes one or more language translation components 723 that may be configured to translate one language to another language during a live conversation between two or more users. Program Data 724 may include a translation database (DB) and/or one or more translation options 725, such as source language, target language, translated language, translated language type, and/or others. In some examples, the applications 722 are arranged to operate with operating system 721 and program data 724 to facilitate one or more of the described methods of the present disclosure. This described basic configuration is illustrated in FIG. 7 by those components within dashed line 701.

Computing device 700 can have additional features or functionality, and additional interfaces to facilitate communications between the basic configuration 701 and any required devices and interfaces. For example, a bus/interface controller 740 can be used to facilitate communications between the basic configuration 701 and one or more data storage devices 750 via a storage interface bus 741. The data storage devices 750 can be removable storage devices 751, non-removable storage devices 752, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media can include volatile and nonvolatile, removable and non-removable media implemented in any method or technology for storage of information, such as computer readable instructions, data structures, program modules, or other data.

System memory 720, removable storage 751, and non-removable storage 752 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 700. Any such computer storage media can be part of device 700.

Computing device 700 can also include an interface bus 742 for facilitating communication from various interface devices (e.g., output interfaces, peripheral interfaces, and communication interfaces) to the basic configuration 701 via the bus/interface controller 740. Example output devices 760 include a graphics processing unit 761 and an audio processing unit 762, which can be configured to communicate to various external devices such as a display or speakers via one or more A/V port 763. Example peripheral interfaces 770 include a serial interface controller 771 or a parallel interface controller 772, which can be configured to communicate with external devices such as input devices (e.g., keyboard, mouse, pen, voice input device, touch input device, etc.) or other peripheral devices (e.g., printer, scanner, etc.) via one or more I/O ports 773. An example communication device 780 includes a network controller 781, which can be arranged to facilitate communications with one or more other computing devices 790 over a network communication via one or more communication ports 782. The communication connection is one example of a communication media. Communication media may typically be embodied by computer readable instructions, data structures, program modules, or other data in a modulated data signal, such as a carrier wave or other transport mechanism, and includes any information delivery media. A “modulated data signal” can be a signal that has one or more of its characteristics set or changed in such a manner as to encode information in the signal. By way of example, and not limitation, communication media can include wired media such as a wired network or direct-wired connection, and wireless media such as acoustic, radio frequency (RF), infrared (IR) and other wireless media. The term computer readable media as used herein can include both storage media and communication media.

Computing device 700 can be implemented as a portion of a small-form factor portable (or mobile) electronic device such as a cell phone, a personal data assistant (PDA), a personal media player device, a wireless web-watch device, a personal headset device, an application specific device, or a hybrid device that include any of the above functions. Computing device 700 can also be implemented as a personal computer including both laptop computer and non-laptop computer configurations.

There is little distinction left between hardware and software implementations of aspects of systems; the use of hardware or software is generally (but not always, in that in certain contexts the choice between hardware and software can become significant) a design choice representing cost vs. efficiency tradeoffs. There are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; if flexibility is paramount, the implementer may opt for a mainly software implementation; or, yet again alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein can be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity; control motors for moving and/or adjusting components and/or quantities). A typical data processing system may be implemented utilizing any suitable commercially available components, such as those typically found in data computing/communication and/or network computing/communication systems. The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

While various embodiments have been disclosed herein, other aspects and embodiments will be apparent to those skilled in art. The various embodiments disclosed herein are for purposes of illustration and are not intended to be limiting, with the true scope and spirit being indicated by the following claims.

What is claimed is:

1. A computer-implemented method for translating a live conversation between a first party using a first communication device and a second party using a second communication device, where the first and second parties are speaking different languages, the method comprising:
receiving translation options from the first communication device;
receiving a source signal from the first communication device, the source signal being associated with a source language;
translating the source signal to a target signal based on the translation options received from the first communication device, the target signal being associated with a target language; and
transmitting the target signal to the second communication device, wherein the source language and the target language are different from one another.

2. The computer-implemented method of claim 1, wherein translating the source signal to a target signal further comprises:
converting the source signal to a source text, the source text being associated with the source language;
translating the source text to a target text, the target text being associated with the target language; and
generating the target signal from the target text such that the target signal is associated with the target language.

3. The computer-implemented method of claim 2, further comprising archiving the source text.

4. The computer-implemented method of claim 2, further comprising archiving the target text.

5. The computer-implemented method of claim 2, further comprising sending a plurality of text messages to the first communication device, the text messages including a log of the live conversation between the first communication device and the second communication device, the log being written in the source language.

6. The computer-implemented method of claim 1, further comprising providing a user-interface to the first communication device for entering the translation options.

7. The computer-implemented method of claim 1, wherein the source signal comprises a voice signal.

8. The computer-implemented method of claim 1, wherein the source language comprises a spoken language.

9. The computer-implemented method of claim 1, wherein the source language comprises a non-spoken language.

10. The computer-implemented method of claim 1, wherein the source signal comprises one or more data packets encapsulating the voice signal.

11. A computing device configured to translate a live conversation between a first party and a second party that are speaking different languages, the computing device comprising:
a computer storage media including computer-readable instructions;
a processor configured by the computer-readable instructions to:
convert a source signal to a source text, the source text and source signal being associated with a source language, the source signal being an audio signal generated from one or more spoken words using the source language;
translate the source text to a target text, the target text being associated with a target language;
generate a target signal, the target signal being associated with the target language; and
transmit the target signal for reception by another computing device.

12. The computing device of claim 11, wherein the processor is further configured by the computer-readable instructions to:
receive an incoming target signal, wherein the incoming target signal is associated with the other computing device, the incoming target signal being associated with the target language;
convert the incoming target signal to an incoming target text, the incoming target text being associated with the target language;
translate the incoming target text to an incoming source text, the incoming source text being associated with the source language;
generate an incoming source signal, the incoming source signal being associated with the source language; and
output the incoming source signal.

13. The computing device of claim 12, wherein the processor is further configured by the computer-readable instructions to:
display a user-interface for setting translation options, the translation options comprising one or more of the source language and/or the target language.

14. The computing device of claim 11, wherein transmitting the target signal to the other computing device is via a voice over internet protocol (VOIP) communication.

15. The computing device of claim 11, wherein the source language comprises a spoken language.

16. A computing device configured to translate a live conversation between a first party on a first communication device and a second party on a second communication device, wherein the first party and the second party are speaking different languages, the computing device comprising:
a computer storage media including computer-readable instructions;
a processor configured by the computer-readable instructions to:
receive a source signal from the first communication device, wherein the source signal is associated with the first party communicating using a source language;
translate the source signal to a target signal based on translation options, the target signal being associated with a target language; and
transmit the target signal to the second communication device, wherein the source language and the target language are different from one another.

17. The computing device of claim 16, wherein the processor is further configured by the computer-readable instructions to:
provide a user-interface in a manner such that the first communication device sets the translation options.

18. The computing device of claim 16, wherein the processor is further configured by the computer-readable instructions to:
receive an incoming target signal from the second communication device, the incoming target signal being associated with the target language;
convert the incoming target signal to an incoming target text, the incoming target text being associated with the target language;
translate the incoming target text to an incoming source text, the incoming source text being associated with the source language;
generate an incoming source signal, the incoming source signal being associated with the source language; and
transmit the incoming source signal to the first communication device.

19. The computing device of claim 18, wherein the processor is further configured by the computer-readable instructions to:
archive the live conversation by storing the source text and incoming source text.

20. The computing device of claim 18, wherein the processor is further configured by the computer-readable instructions to:
send a plurality of text messages to the first communication device, the text messages including a log of the live conversation between the first communication device and the second communication device, the log being written in the source language.
